(19) United States
(12) Patent Application Publication
(10) Pub. No.: US 2026/0049566 A1
(43) Pub. Date: Feb. 19, 2026

(54) TWO-STROKE EXHAUST MANIFOLD AND ASSOCIATED SYSTEMS AND METHODS

(71) Applicant: Starting Line Products, Inc., Idaho Falls, ID (US)

(72) Inventors: Allen Roberts, Idaho Falls, ID (US); Brian Earl Hokanson, Idaho Falls, ID (US)

(21) Appl. No.: 19/297,243

(22) Filed: Aug. 12, 2025

Related U.S. Application Data
(60) Provisional application No. 63/682,971, filed on Aug. 14, 2024.

(51) Int. Cl. F01N 13/10; F01N 13/18; F02B 75/02

(52) U.S. Cl. CPC F01N 13/10; F01N 13/1811; F02B 75/02; F02B 2075/025

(57) ABSTRACT

An exhaust manifold includes at least two flanges. The exhaust manifold further includes a first tube extending at a first constant angle from a first flange of the at least two flanges. The exhaust manifold also includes a second tube extending at a second constant angle from a second flange of the at least two flanges. The first tube and the second tube join at a collector, where the first tube and the second tube form an acute angle between the first tube and the second tube at the collector.

### CROSS-REFERENCE TO RELATED APPLICATIONS

This application claims the benefit under 35 U.S.C. § 119 (e) of U.S. Provisional Patent Application Ser. No. 63/682,971, filed Aug. 14, 2024, the disclosure of which is hereby incorporated herein in its entirety by this reference.

### TECHNICAL FIELD

This disclosure relates generally to two-stroke internal combustion engine exhaust systems, specifically exhaust manifolds and associated systems and methods.

### BACKGROUND

Internal combustion engines operate by pulling air or an air fuel mixture into a combustion chamber, compressing the air or air fuel mixture in the combustion chamber, expanding an air fuel mixture, which may be the air fuel mixture pulled into the combustion chamber in the earlier steps or may be an air fuel mixture formed by inputting fuel into the compressed air in the combustion chamber, through combustion of the air fuel mixture, and exhausting the combustion byproducts from the combustion chamber. Increasing the efficiency of any one of the four steps may result in increased power (e.g., horsepower, torque) and/or improved efficiency (e.g., improved power output for the fuel input into the engine).

Exhaust systems for internal combustion engines may be designed to facilitate fast and efficient exhaust of all the combustion byproducts. Improvements in the speed of the exhaust of the combustion byproducts may facilitate longer periods of time for pulling in the air or air fuel mixture, which may improve the efficiency of the step of pulling in the air or air fuel mixture. Increasing the amount of the combustion byproducts removed from the combustion chamber may provide a greater volume of the combustion chamber for the fresh air or air fuel mixture, which may improve the efficiency of the combustion step.

### BRIEF SUMMARY

Embodiments of the disclosure include an exhaust manifold. The exhaust manifold includes at least two flanges. The exhaust manifold further includes a first tube extending at a first constant angle from a first flange of the at least two flanges. The exhaust manifold also includes a second tube extending at a second constant angle from a second flange of the at least two flanges. The first tube and the second tube join at a collector, where the first tube and the second tube form an acute angle between the first tube and the second tube at the collector.

Another embodiment of the disclosure includes an exhaust system. The exhaust system includes at least two flanges configured to connect to exhaust ports of an internal combustion engine. The exhaust system further includes a first tube extending from a first flange of the at least two flanges at a first constant angle relative to a plane formed between the at least two flanges. The first constant angle is in a range from about 50° to about 80°. The exhaust system also includes a second tube extending from a second flange of the at least two flanges at a second constant angle. The second constant angle is in a range from about 50° to about 80°. The exhaust system further includes a collector operatively coupled to a tuned pipe; the first tube and the second tube joining at the collector.

Other embodiments of the disclosure include a method of forming an exhaust manifold. The method includes coupling a first tube to a first flange, the first tube extending from the first flange at a first constant angle in an XY plane. The method further includes coupling a second tube to a second flange, the second tube extending from the second flange at a second constant angle in the XY plane, the second angle being equal and opposite to the first angle. The method also includes joining the first tube and the second tube at a collector, the first tube and the second tube having a same length.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIGS. 1-3 illustrate an engine assembly in accordance with embodiments of the disclosure;

FIG. 4 illustrates a perspective view of an exhaust manifold in accordance with embodiments of the disclosure;

FIG. 5 illustrates a top-down view of the exhaust manifold of FIG. 4;

FIG. 6 illustrates a cross-sectional view of the exhaust manifold of FIG. 4;

FIG. 7 illustrates a side view of the exhaust manifold of FIG. 4;

FIG. 8 illustrates a flange side view of the exhaust manifold of FIG. 4; and

FIGS. 9-11 illustrate collector side perspective views of the exhaust manifold of FIG. 4.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional exhaust system fabrication techniques employed in the industry. The structures described below do not form a complete exhaust system. Only those process acts and structures necessary to understand the embodiments of the disclosure are described in detail below. Additional acts and/or structures to form a complete exhaust system from the structures may be included through conventional techniques.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the term “internal combustion engine” or “engine” means and includes any engine configured to operate through the combustion of an air fuel mixture, such as gasoline engines, four stroke engines, two stroke engines, rotary engines, diesel engines, direct injection engines, carbureted engines, fuel injected engines, etc.

As used herein, the phrase “coupled to” refers to structures operatively connected with each other, such as fluidically connected to form a direct fluid path between the two structures or through an indirect connection (e.g., by way of another structure).

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “beneath,” “below,” “lower,” “bottom,” “above,” “upper,” “top,” “front,” “rear,” “left,” “right,” and the like, may be used for case of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure. With reference to the drawings, a “horizontal” or “lateral” direction may be perpendicular to an indicated “Z” axis, and may be parallel to an indicated “X” axis and/or parallel to an indicated “Y” axis; and a “vertical” or “longitudinal” direction may be parallel to an indicated “Z” axis, may be perpendicular to an indicated “X” axis, and may be perpendicular to an indicated “Y” axis.

Exhaust systems for internal combustion engines may be designed to facilitate fast and efficient exhaust of all the combustion byproducts. The speed and efficiency of an exhaust system may be improved by improving the portions of the exhaust closest to the internal combustion, such as the exhaust manifold, which is configured to couple the exhaust system to the internal combustion engine. The exhaust manifold may be improved by decreasing a number and degree of changes in direction of the combustion byproducts as they leave the combustion chamber. This may decrease back pressure and increase or preserve soundwave amplitudes within the exhaust manifold caused by flow restrictions in the exhaust manifold.

The exhaust manifold may also be improved by increasing a length of the individual pipes leaving the internal combustion engine. Increasing the length of the individual pipes may decrease interaction between separate combustion chambers of the engine. For example, in an engine having multiple combustion chambers, the combustion chambers may be configured to carry out the different steps of the process at different times. Short distances to common or shared portions of the exhaust system may result in exhaust pressure from one combustion chamber increasing back pressure or interrupting sonic waves at another combustion chamber during the exhaust step. Increasing the length of the individual pipes may decrease the interaction between individual combustion chambers, which may decrease back pressure and increase or preserve sound wave amplitudes in the exhaust system.

Exhaust systems run external to the associated engine, such that space considerations also affect the design of an exhaust system. In smaller equipment, such as snow mobiles, all-terrain vehicles (ATVs), utility vehicles (UTVs), motorcycles, and other small engine equipment (e.g., lawn mowers, lawn tractors, go carts, dune buggies, etc.), the space for an exhaust manifold may be small. Embodiments of the disclosure may facilitate improvements to exhaust systems in smaller equipment by improving flow characteristics in an exhaust manifold while maintaining a smaller size that can fit within the space constraints of the smaller equipment.

In two-stroke internal combustion engines the design of the exhaust system can provide additional gains in efficiency. Two-stroke internal combustion engines operate by utilizing the crankcase and piston to generate compression, power, exhaust, and intake. The cycle follows with the two-stroke piston rising on compression, an underside of piston creates a partial vacuum in the crankcase while an intake port (e.g., cylinder wall port, reed valve, rotary disc valve) opens allowing air volume into the crankcase through a carburetor or throttle body. As the piston continues upward and passes a point in a range of about 5° to 40° from top dead center a spark plug ignites into the compressed air-fuel mixture burning the mixture and increasing the pressure within the cylinder driving the piston down the bore and driving the crankshaft. The descending piston compresses the fuel-air mixture within the crankcase. An exhaust port is exposed in the upper cylinder wall, and at the same time while the piston descends it exposes two or more fresh-charge ports. The pressure change in the cylinders now drives the process; with the exhaust port in the upper portion of the cylinder releasing pressure pulling the air-fuel mixture from the high-pressure crankcase area in the lower part of the cylinder. This continues while the piston reaches bottom dead center, the air-fuel mixture will continue to shift from the high-pressure crankcase to the low-pressure top of the cylinder. As the cycle completes it will cover the first of the transfer ports separating the upper area from the lower once more beginning the pressure change again.

In a two-stroke engine, there is a time where the transfer ports are closed but the exhaust port remains open that, if left without correction or assistance, will allow for the air-fuel mixture to be released reducing efficiency of the engine. This may be counteracted by the exhaust system. For example, the shape and dimensions of the exhaust assembly may result in high-pressure sound wave reflection of the original pressure pulse released by the exhaust at the beginning of the cycle. The high-pressure sound wave reflection may cause a counteracting force to the changes in pressure. Thus, the high-pressure sound wave reflection may substantially prevent the air-fuel mixture from exiting the cylinder through the exhaust port, which may result in a higher performing engine. For example, rather than a reduction in efficiency caused by expelling un-used air-fuel mixture the engine instead creates a power gain by reducing the loss in air-fuel mixture and boosting combustion chamber pressure.

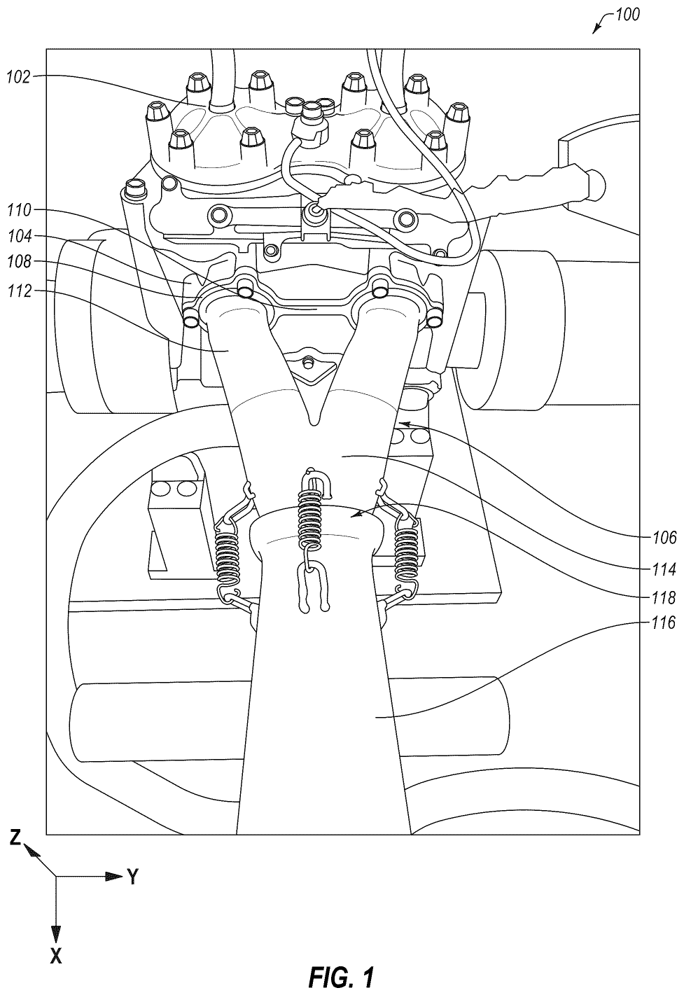

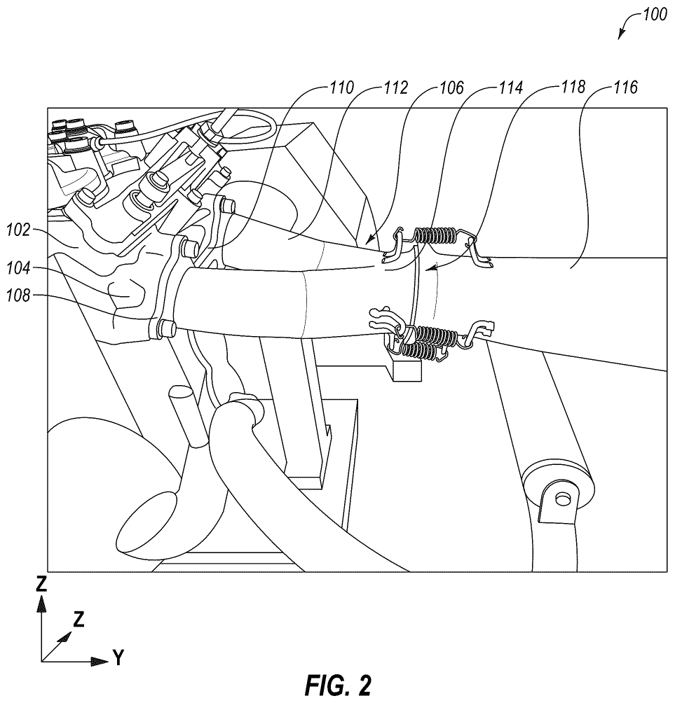

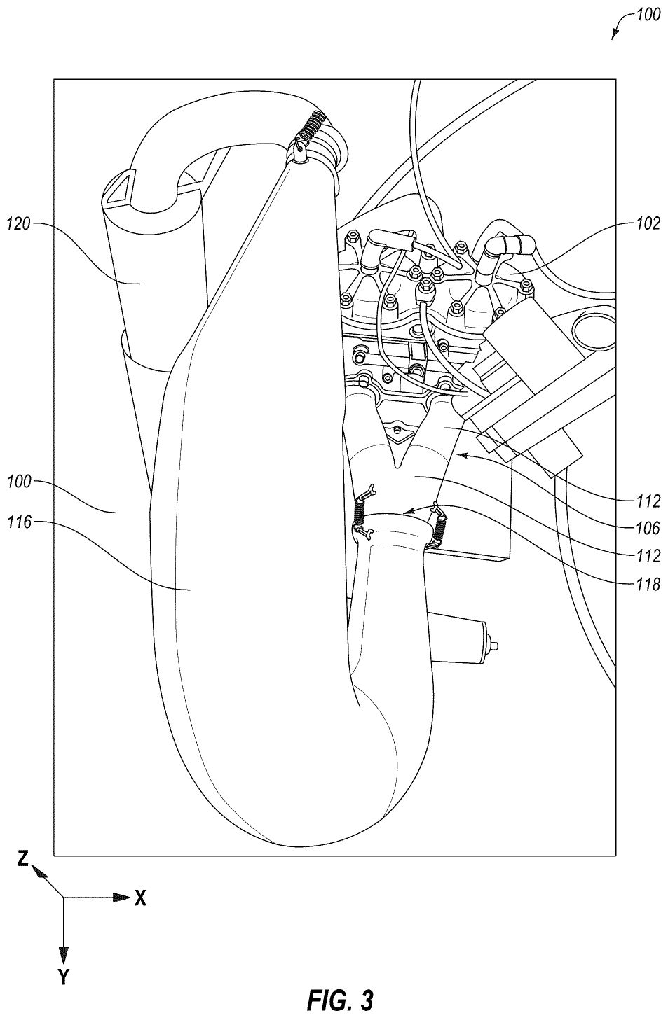

FIGS. 1 through 3 illustrate an engine assembly 100. The engine assembly 100 includes an internal combustion engine 102 including an exhaust manifold 106 coupled to an exhaust port 104 of the internal combustion engine 102. The exhaust manifold 106 includes a flange 108 configured to be coupled to each exhaust port 104 of the internal combustion engine 102. In the embodiment illustrated in FIGS. 1 and 2, the internal combustion engine 102 includes two adjacent exhaust ports 104.

The exhaust manifold 106 also includes two flanges 108 having complementary spacing to the exhaust ports 104. The exhaust manifold 106 also includes a bridge 110 extending between the flanges 108. The bridge 110 may be configured to maintain a position of the flanges 108. In some embodiments, the flanges 108 and the bridge 110 are formed from a single substantially flat piece of material, such as steel plate or aluminum plate, having a thickness sufficient to maintain rigidity of the flanges 108 and the bridge 110 in a high temperature environment. For example, the flanges 108 and the bridge 110 may have a thickness sufficient to avoid warping at normal operating temperatures of the exhaust ports 104 of the internal combustion engine 102. The flanges 108 and the bridge 110 may have a thickness in a range from about 0.125 in (3.175 mm) to about 0.75 in (19.05 mm), such as from about 0.25 in (6.35 mm) to about 0.5 in (12.7 mm), or from about 0.25 in (6.35 mm) to about 0.375 in (9.525 mm).

The exhaust manifold 106 includes two tubes 112 extending from the flanges 108. In some embodiments, the tubes 112 are coupled to the exhaust manifold 106 through a welded or soldered connection. In other embodiments, the tubes 112 may extend through the flanges 108 and include a flare configured to be clamped between the flanges 108 and the exhaust ports 104. As illustrated in FIG. 1, the tubes 112 extend at substantially constant angles relative to the flanges 108 in the horizontal plane (e.g., the XY plane), such that when viewed in the XY plane, each of the tubes 112 are substantially straight between the flanges 108 and a collector 114, where the tubes 112 are joined together. The collector 114 is configured to join the two tubes 112 into a common pipe. The collector 114 also includes a connection 118 configured to couple the collector 114 to a tuned pipe 116.

The tuned pipe 116 may include a muffler 120 (e.g., resonator, resonator tube, silencer, baffle, etc.) configured to reduce a sound output of the engine assembly 100.

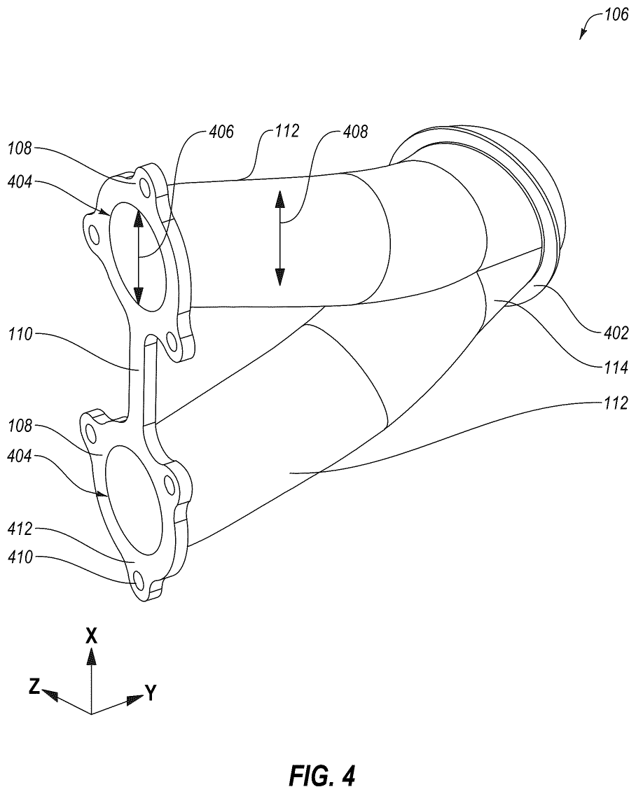

FIG. 4 illustrates a perspective view of the exhaust manifold 106. The exhaust manifold 106 extends between the flanges 108 and a collector flange 402. The collector flange 402 may form the exhaust manifold 106 side of the connection 118 (FIGS. 1-3). In other embodiments, the collector 114 may form a socket configured to receive the exhaust system to form the connection 118 (FIGS. 1-3). The collector flange 402 may be configured to be secured to the tuned pipe 116 (FIGS. 1-3), through a clamping connection (e.g., spring clamp, screw clamp, cam operated clamp, etc.), through a direct hardware connection (e.g., bolts, threaded studs, pins, rivets, etc.), or a welded connection.

As discussed above, the flanges 108 are configured to couple the exhaust manifold 106 to exhaust ports 104 (FIGS. 1-3) of the internal combustion engine 102 (FIGS. 1-3). The flanges 108 may include openings 404 configured to form a fluid connection between the exhaust ports 104 (FIGS. 1-3) and the tubes 112 of the exhaust manifold 106. The openings 404 may be substantially a same size and shape as the associated openings (not shown) in the exhaust ports 104 (FIGS. 1-3). In other embodiments, the openings 404 may vary in size and shape relative to the associated opening in the exhaust ports 104 (FIGS. 1-3). An inner dimension 406 of the openings 404 may be substantially the same as an inner dimension 408 of the tubes 112. Matching the inner dimensions 406 of the openings 404 and the inner dimensions 408 of the tubes 112 may reduce pressure build up at the transition from the exhaust port 104 (FIGS. 1-3) to the associated tube 112.

The flanges 108 may include multiple apertures 410 configured to receive hardware, such as bolts or studs for securing the flanges 108 to the exhaust ports 104 (FIGS. 1-3) of the internal combustion engine 102 (FIGS. 1-3). The flanges 108 are connected through a bridge 110. The bridge 110 is configured to maintain a relative position of the flanges 108. For example, the bridge 110 may be configured to maintain sealing surfaces 412 of the flanges 108 in a same plane (e.g., the XZ plane). Maintaining the sealing surfaces 412 of the flanges 108 in the same plane may facilitate the formation of a seal between the sealing surfaces 412 of the flanges 108 and the exhaust ports 104 (FIGS. 1-3). The bridge 110 may also be configured to resist temperature induced deformation (e.g., warping) of the flanges 108. Deformation of the flanges 108 and/or the tubes 112 may change an orientation of the flanges 108, which may break the seal between the sealing surfaces 412 of the flanges 108 and the exhaust ports 104 (FIGS. 1-3). The deformation may also change an orientation of the tubes 112 relative to the exhaust ports 104 (FIGS. 1-3), which may result in increases in pressure build-up in the interface between the exhaust ports 104 (FIGS. 1-3) and the tubes 112. Therefore, preventing temperature-induced deformation may facilitate improved sealing between the sealing surfaces 412 of the flanges 108 and the exhaust ports 104 (FIGS. 1-3) and maintaining the designed orientation between the exhaust ports 104 (FIGS. 1-3) and the tubes 112 through temperature cycles of the internal combustion engine 102 (FIGS. 1-3).

As discussed above, the tubes 112 may be substantially straight in the XY plane. As illustrated in FIG. 4, the tubes 112 may be curved in the vertical plane (e.g., the YZ plane). The curve in the tubes 112 may change an orientation of the collector flange 402 relative to the flanges 108. As illustrated in FIG. 4, the collector flange 402 extends in an angled plane (e.g., a plane intersecting with each of the X, Y, and Z axes). The curve in the tubes 112 may be different for different applications. For example, the curve in the tubes 112 may be formed to match the collector flange 402 orientation and position to an existing position of the tuned pipe 116 (FIGS. 1-3). In some examples, the curve in the tubes 112 may be configured to prevent contact between the exhaust manifold 106 and other components in the associated equipment or vehicle.

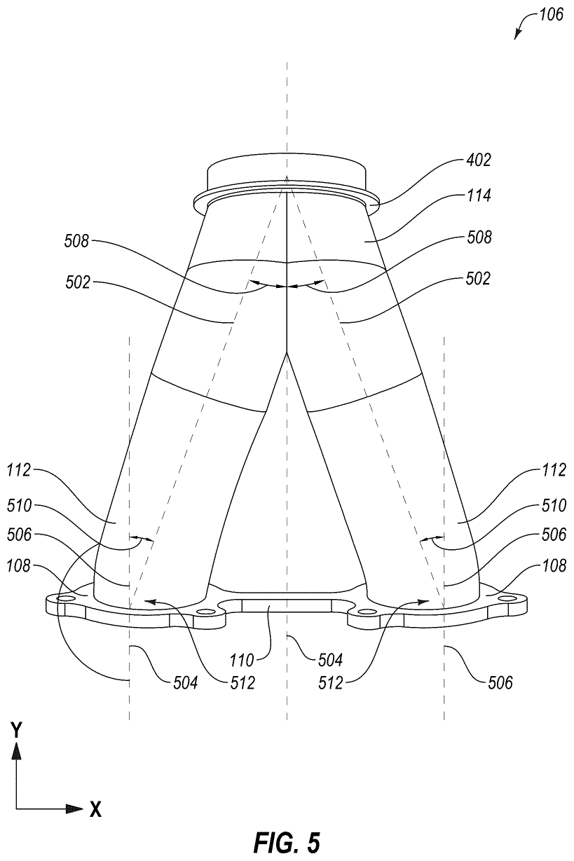

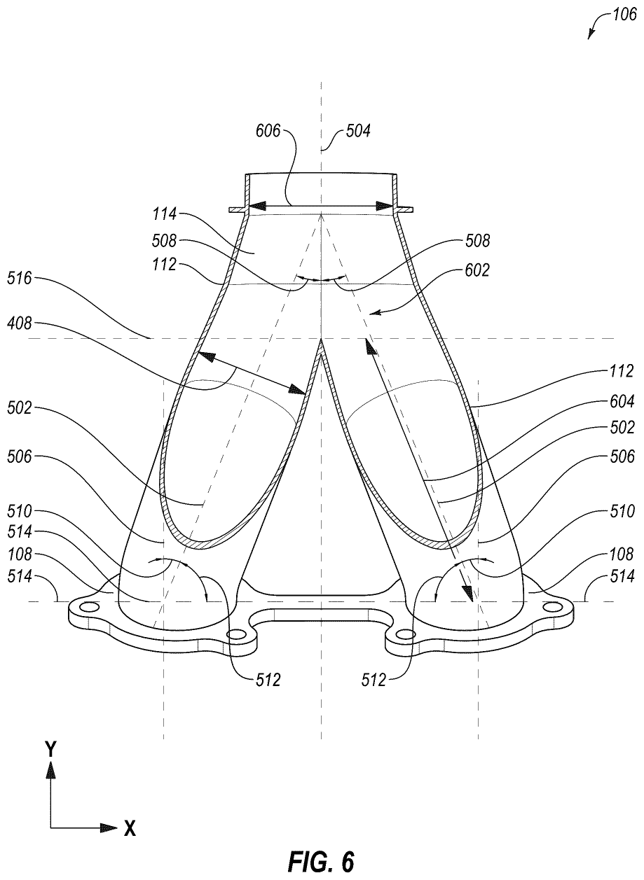

FIGS. 5 and 6 illustrate views of the exhaust manifold 106 in the XY plane. FIG. 5 illustrates a top-down view of the exhaust manifold 106 in the XY plane and FIG. 6 illustrates a cross-sectional view of the exhaust manifold 106 in the XY plane. As discussed above, the tubes 112 are substantially straight in the XY plane. The tubes 112 have tube axes 502 that extend in a substantially straight line from the flanges 108 to the collector 114. The tubes 112 may be tapered, such that the inner dimension 408 of the tubes 112 gradually increases along the length of the tubes 112. For example, the inner dimension 408 of each tube 112 may gradually increase from the inner dimension 406 (FIG. 4) of the opening 404 in the associated flange 108 to a larger inner dimension 408 as the tube 112 reaches the collector 114.

The increase in the inner dimension 408 of the tube 112 may be in a range from about a 5% increase to about a 50% increase, such as in a range from about a 7% increase to about a 40% increase, or from about a 10% increase to about a 30% increase. For example, the inner dimension 406 (FIG. 4) of the opening 404 may be in a range from about 1.57 in (40 mm) to about 2.36 in (60 mm), such as about 1.96 in (50 mm) and the inner dimension 408 of the tube 112 when the tube 112 reaches the collector 114 may be in a range from about 1.73 in (44 mm) to about 3.07 in (78 mm), such as about 2.17 in (55 mm).

The tube axes 502 may form angles 508 with a manifold axis 504. The angles 508 between each of the tube axes 502 and the manifold axis 504 may be acute angles. For example, the angles 508 between each of the tube axes 502 and the manifold axis 504 may be in a range from about 10° to about 32.5°, such as a range from about 15° to about 25° or about 20°. The angles 508 between each of the tube axes 502 and the manifold axis 504 may be substantially the same. Such that an angle between the tube axes 502 may be about two times (2X) the angle 508 between either one of the tube axes 502 and the manifold axis 504. Thus, the angle between the tube axes 502 may be in a range from about 20° to about 65°, such as in a range from about 30° to about 50° or about 40°.

The tube axes 502 may also form angles 510 with port axes 506. The port axes 506 may be the axes of the exhaust ports 104 and the openings 404 in the flanges 108. The tube axes 502 may form angles 510 with the port axes 506 that are substantially the same as the angles 508 between the tube axes 502 and the manifold axis 504. For example, the angle 510 between a tube axis 502 and the associated port axis 506 may be in a range from about 10° to about 40°, such as a range from about 15° to about 25° or about 20°.

The tube axes 502 may also form angles 512 with the associated flanges 108 (e.g., the plane 514 of flanges 108 or the XZ plane). The angle 512 between each tube axis 502 and the associated flange 108 may be a complementary angle to the angle 510 between the tube axis 502 and the associated port axis 506 (e.g., the sum of the angle 510 and the angle 512 may be) 90°. Therefore, the angle 512 may be in a range from about 50° to about 80°, such as in a range from about 65° to about 75° or about 70°.

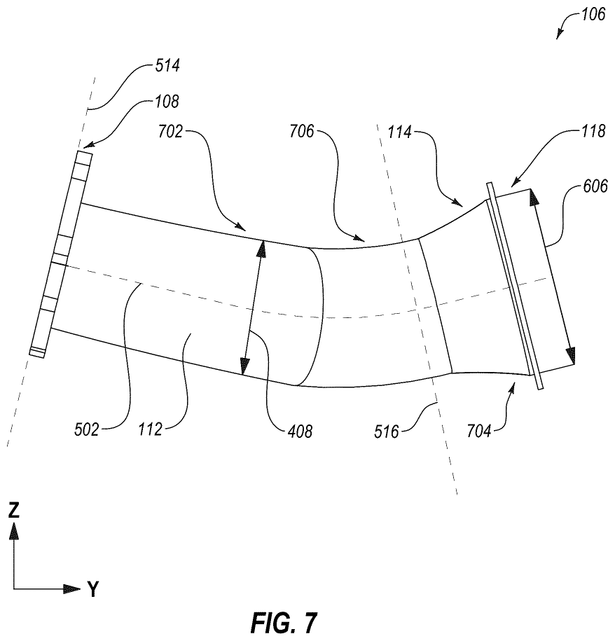

The tubes 112 may join together at the collector 114 to form a common plenum 602. A tube length 604 may be defined as a distance between the flange 108 and the common plenum 602. Specifically, the tube length 604 is the distance along tube axis 502 between the flange 108 and a cross-sectional plane 516 of the exhaust manifold 106 at the intersection between the two tubes 112 at the manifold axis 504. The tube axis 502 extends along the tube 112 at a center point of the tube 112. Therefore, the tube length 604 is the distance between the intersection of the tube axis at the center of the tube 112 and the plane 514 of the flanges 108 and the intersection of the tube axis 502 at the center of the tube 112 and the cross-sectional plane 516 of the exhaust manifold 106 at the intersection between the two tubes 112. As discussed in further detail below, with respect to FIG. 7, the tube 112 may include a curve or arcuate shape in the YZ plane in at least a portion of the tube 112, such that the tube axis 502 also includes a curve or arcuate shape in the YZ plane. Therefore, the tube length 604 may be greater than a straight line between the plane 514 of the flanges 108 and the cross-sectional plane 516. Increasing the tube length 604 may reduce pressure induced at the exhaust ports 104 by exhaust from adjacent exhaust ports 104. For example, adjacent exhaust ports 104 on the internal combustion engine 102 may open at different times. Therefore, a first exhaust port 104 may begin exhausting the combustion byproducts while a second exhaust port 104 remains closed. When the second exhaust port 104 opens, the pressure from the first exhaust port 104 may remain in the exhaust system. As the tube length 604 increases, the pressure from the first exhaust port 104 resisting the exhaust from the second exhaust port 104 may be reduced, which may increase efficiency of the exhaust through each of the exhaust ports 104. The tube length 604 may be in a range from about 4 in (101.6 mm) to about 10 in (254 mm), such as from about 4.4 in (112 mm) to about 8.8 in (224 mm) or from about 5 in (127 mm) to about 7 in (177.8 mm) or about 6.8 in (173 mm).

The tube length 604 may be combined with an internal length of the exhaust port 104 (FIG. 1) (e.g., a length of the exhaust port from the cylinder to the flange 108) to define a total tube length. For example, the internal length of the exhaust port 104 may be in a range from about 50 mm to about 70 mm, such that the total tube length may be in the range of from about 50 mm to about 70 mm longer than the tube length 604. The total tube length may combined with area major dimension (e.g., diameter, width, or apothem) of the opening 404 in the flange 108 to define a flow ratio for each tube 112 of the exhaust manifold 106. For example, a tube 112 having a tube length 604 of about 225 mm coupled to an exhaust port 104 having an exhaust port length of about 63 mm results in a total tube length of 288 mm. If the opening 404 in the flange 108 has a diameter of about 50 mm, the flow ratio would be about 5.75:1. The flow ratio may be greater than about 4.8:1, such as in a range from about 4.8:1 to about 6:1, such as from about 5:1 to about 5.75:1.

Once the tubes 112 are fully merged into the collector 114, the collector 114 may define a final inner dimension 606. The inner dimension 606 may be greater than the final inner dimension 408 of the tubes 112, where the tubes 112 reach the collector 114 and less than two times the inner dimension 408 of the tubes 112 where the tubes 112 reach the collector 114. The area defined by the inner dimension 606 of the collector 114 may be greater than either individual tube 112 and less than the combined area of the two tubes 112.

FIG. 7 illustrates a side view of the exhaust manifold 106 in the YZ plane. As discussed above, the tubes 112 may be curved in the YZ plane. The curve in the YZ plane may be configured to change the position and/or orientation of the collector 114, such as to match the position and orientation to a position of the tuned pipe 116 (FIGS. 1-3) or to fit the exhaust manifold 106 within the space constraints of the associated equipment or vehicle.

The tube 112 may include a straight portion 702 and a curved portion 706. The straight portion 702 may extend from the flange 108 to the curved portion 706. The curved portion 706 may be proximate the collector 114. Thus, the tube 112 is substantially straight in a region proximate the flange 108. The straight portion 702 may be configured to substantially reduce restrictions to the flow of combustion byproducts in the region proximate the exhaust port 104 (FIGS. 1-3), which may reduce back-pressure and increase sound wave amplitude on the exhaust ports 104 (FIGS. 1-3).

As discussed above, an inner dimension 408 of the tube 112 may gradually increase in size along the length of the tube 112. In some embodiments, the tube 112 increases to the final inner dimension 408 in the straight portion 702 and remains at the final inner dimension 408 through the curved portion 706. The curve radius of the curved portion 706 may be at least about two times the inner dimension 408 of the tube 112, such as at least about four times the inner dimension 408 of the tube 112. The curved portion 706 may be formed through a tube bending process, such as mandrel bending process.

The collector 114 may include a transition region 704 where the cross-sectional dimensions of the exhaust manifold 106 transition from the dimensions of the tubes 112 to the final dimensions of the collector 114. For example, the collector 114 may transition from the inner dimensions 408 of the two tubes 112 to the inner dimension 606 of the collector 114 in the transition region 704. As illustrated in FIG. 7, the transition region 704 includes an increase from the inner dimension 408 of the tube 112 to the inner dimension 606 of the collector 114 in the YZ plane. As illustrated in FIGS. 5 and 6, the transition region 704 also includes a decrease from the combined inner dimensions 408 of the joining tubes 112 to the inner dimension 606 of the collector 114 in the XY plane.

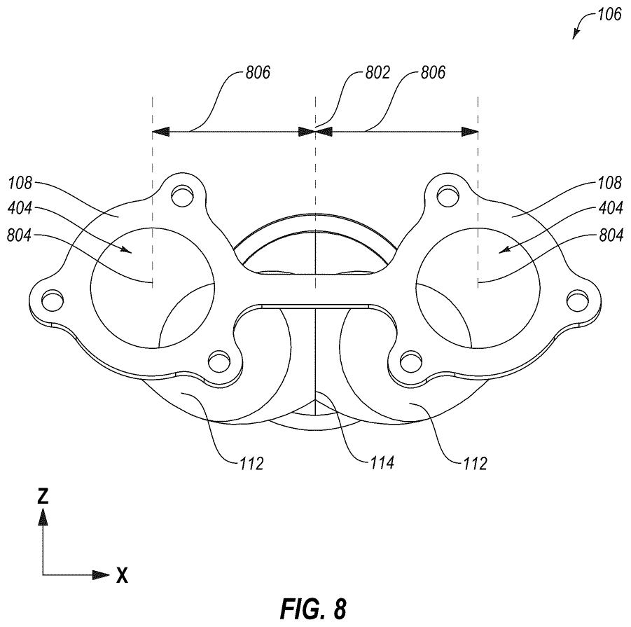

FIG. 8 illustrates a view of the exhaust manifold 106 in the XZ plane from the flange 108 side of the exhaust manifold 106. The exhaust manifold 106 may be substantially symmetrical across a center line 802 of the exhaust manifold 106. Each of the openings 404 defined in the flanges 108 may be equally spaced from the center line 802 in opposite directions along the X axis. For example, center lines 804 of the openings 404 may be positioned at equal distances 806 from the center line 802 of the exhaust manifold 106.

The equal spacing may be facilitated by positioning the collector 114 to be centered on the center line 802 of the exhaust manifold 106. The collector 114 may be centered on the center line 802 of the exhaust manifold 106 by forming the tubes 112 to have equal lengths and similar shapes. For example, the tubes 112 may have a same length and may have mirrored geometry (e.g., the curves and angles of the tubes 112 may be mirrored or reversed across the center line 802 of the exhaust manifold 106). In some embodiments, the angles (e.g., angle 508, angle 510, angle 512) of a first tube 112 are equal and opposite the angles of a second tube. In other embodiments, the exhaust manifold 106 may have an asymmetric design. For example, the tubes 112 may have different lengths or extend at different angles. For example, one or more of the angles 508, 510, 512 of the first tube 112 may be different from the corresponding angles 508, 510, 512 of the second tube 112.

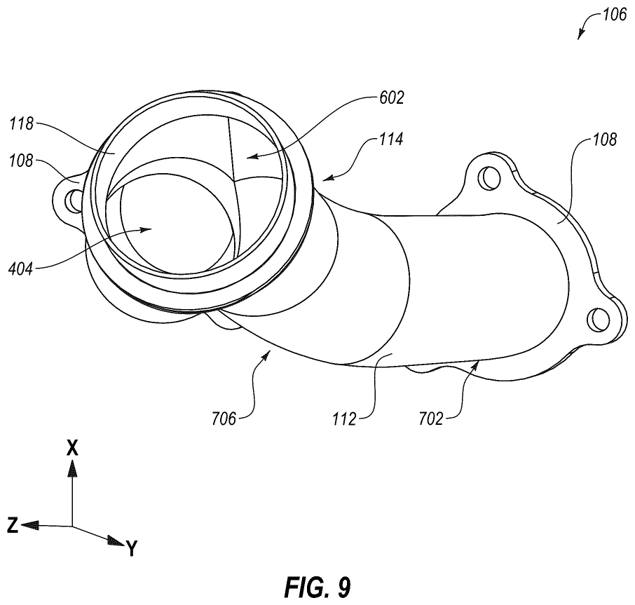

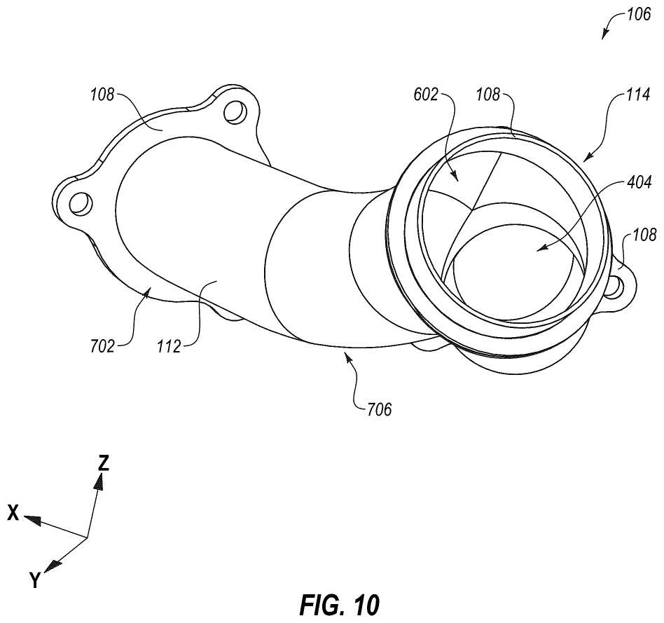

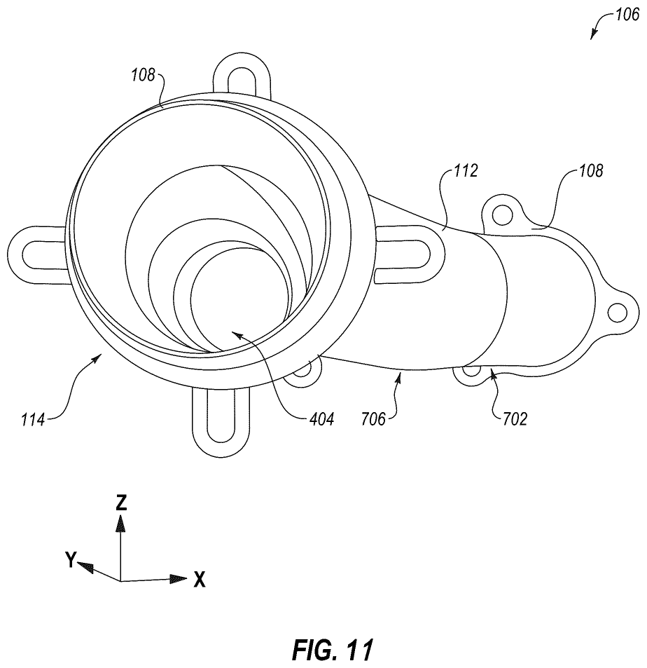

FIGS. 9-11 illustrate perspective views of the exhaust manifold 106 from the collector 114 side of the exhaust manifold 106. A path through the tubes 112 may be defined by the straight portion 702 and the curved portion 706 of the tubes 112. As illustrated in each of FIGS. 9-11, the path through the tubes 112 may be sufficiently straight that a portion of the opening 404 in each of the flanges 108 may be visible through the open end of the collector 114. For example, at least 50% of the area of each opening 404 may be viewed through the open end of the collector 114, such as at least 75% of the area of each opening 404 or 100% of the area of each opening 404. The substantially straight path through the tubes 112 may facilitate efficient sound wave travel through the tubes 112. Thus, the substantially straight path through the tubes 112 may result in greater pressure of the sound wave reflection at the exhaust ports 104 (FIGS. 1-3). Accordingly, if the tubes 112 have sufficient length, the increased pressure of the sound wave reflection may increase efficiency of the combustion in the cylinder by substantially preventing the loss of air-fuel mixture into the exhaust system and increasing the combustion pressure in the cylinder.

The path through the tubes 112 may be substantially free of obstructions between the opening 404 and the open end of the collector 114, as illustrated in FIGS. 9-11. The obstruction free path may reduce flow resistance and increase sound wave amplitude in the exhaust manifold 106. Reducing the restriction to flow through the exhaust manifold 106 may increase particle flow through the exhaust manifold 106. Increasing particle flow through the exhaust manifold 106 may improve performance and/or efficiency of the associated internal combustion engine 102.

Embodiments of the disclosure may provide improved flow characteristics and reduced back pressure within an exhaust system. The improved flow characteristics and reduced back pressure may facilitate faster evacuation of the combustion byproducts from a combustion chamber and a more complete evacuation of the combustion products from the combustion chamber. Improvements in the speed of the exhaust of the combustion byproducts may facilitate longer periods of time for pulling in the air or air fuel mixture, which may improve the efficiency of the step of pulling in the air or air fuel mixture into the combustion chamber. Increasing the completeness of the combustion byproduct removal from the combustion chamber may provide a greater volume of the combustion chamber for the fresh air or air fuel mixture, which may improve the efficiency of the combustion step. Improvements in the intake process and combustion process may improve the power output from the engine and the efficiency of the engine.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. An exhaust manifold comprising:
at least two flanges;
a first tube extending at a first constant angle from a first flange of the at least two flanges;
a second tube extending at a second constant angle from a second flange of the at least two flanges; and
the first tube and the second tube joining at a collector, wherein the first tube and the second tube form an acute angle between the first tube and the second tube at the collector.

2. The exhaust manifold of claim 1, wherein the first tube extends at the first constant angle in an XY plane.

3. The exhaust manifold of claim 2, wherein the second tube extends at a second constant angle in the XY plane, the second constant angle mirroring the first constant angle.

4. The exhaust manifold of claim 1, wherein the acute angle is in a range from about 30° to about 50°.

5. The exhaust manifold of claim 1, wherein the first flange includes a first opening and the first tube defines a straight path between the first opening and the collector.

6. The exhaust manifold of claim 1, further comprising a bridge extending between the first flange and the second flange.

7. The exhaust manifold of claim 1, wherein the collector is centered on a center line of the exhaust manifold.

8. The exhaust manifold of claim 7, wherein a first distance from the center line of the exhaust manifold to a first center line of the first flange is the same as a second distance from the center line of the exhaust manifold to a second center line of the second flange.

9. The exhaust manifold of claim 7, wherein a first distance along a central axis of the first tube from the center line of the exhaust manifold to a first center line of the first flange is in a range from about 4 in to about 10 in.

10. An exhaust system comprising:
at least two flanges configured to connect to exhaust ports of an internal combustion engine;
a first tube extending from a first flange of the at least two flanges at a first angle relative to a plane formed between the at least two flanges, the first angle is in a range from about 50° to about 80°;
a second tube extending from a second flange of the at least two flanges at a second angle, the second angle is in a range from about 50° to about 80°;
a collector operatively coupled to a tuned pipe; and
the first tube and the second tube joining at the collector.

11. The exhaust system of claim 10, wherein the first constant angle and the second constant angle are in an XY plane.

12. The exhaust system of claim 11, wherein the first constant angle and the second constant angle are mirrored angles across a center line between the first flange and the second flange.

13. The exhaust system of claim 10, wherein the first tube has a first inner dimension at the first flange and a second inner dimension at the collector, the second inner dimension being larger than the first inner dimension.

14. The exhaust system of claim 13, wherein the second inner dimension is in a range from about 10% larger than the first inner dimension to about 30% larger than the first inner dimension.

15. The exhaust system of claim 13, wherein the first tube is tapered gradually changing from the first inner dimension to the second inner dimension.

16. The exhaust system of claim 13, wherein the first tube defines a flow ratio greater than 4.8:1.

17. The exhaust system of claim 13, wherein the collector has a third final inner dimension.

18. The exhaust system of claim 17, wherein the third final inner dimension is greater than the second inner dimension and less than two times the second inner dimension.

19. A method of forming an exhaust manifold comprising:
coupling a first tube to a first flange, the first tube extending from the first flange at a first constant angle in an XY plane;
coupling a second tube to a second flange, the second tube extending from the second flange at a second constant angle in the XY plane, the second angle being equal and opposite to the first angle; and
joining the first tube and the second tube at a collector.

20. The method of claim 19, wherein joining the first tube and the second tube at the collector further comprises forming an angle between the first tube and the second tube in a range from about 20° to about 65°.
